(19) United States
(12) Patent Application Publication
(10) Pub. No.: US 2013/0085957 A1
(43) Pub. Date: Apr. 4, 2013

(54) METHOD AND SYSTEM FOR AUTOMATIC PRODUCT REPLENISHMENT

(71) Applicant: Drake D. Stimson, Terrace Park, OH (US)

(72) Inventor: Drake D. Stimson, Terrace Park, OH (US)

(73) Assignee: Precision Dermatology, Inc., Cumberland, RI (US)

(21) Appl. No.: 13/249,960

(22) Filed: Sep. 30, 2011

(51) Int. Cl. G06Q 10/08

(52) U.S. Cl. 705/330

(57) ABSTRACT

A computer-implemented method and system are provided for automatic product replenishment. The method includes the steps of: (a) receiving an order for products to be sent to a customer on a given replenishment schedule; (b) determining a product replenishment plan for evolving the products to be sent to the customer to improve product performance; and (c) automatically sending products to the customer in accordance with the product replenishment plan over the replenishment schedule.

### BACKGROUND

The present application relates generally to an automatic product replenishment system that evolves products to be replenished to improve product performance.

Automatic product replenishment is an important commerce tool for retailers and manufacturers that sell directly to consumers. Automatic replenishment programs increase consumer loyalty and promote continued product usage. For consumers, automatic replenishment offers convenience and saves time. Consumers do not have to remember to replenish their products or make repeated product purchases. Ideally, replenishment shipments are timed such that a replacement product arrives just as the consumer's existing inventory of the product is about to be exhausted.

### BRIEF SUMMARY OF THE DISCLOSURE

In accordance with one or more embodiments, a computer-implemented method is provided for automatic product replenishment. The method includes the steps of: (a) receiving an order at a computer system for products to be sent to a customer on a given replenishment schedule; (b) determining a product replenishment plan using the computer system for evolving the products to be sent to the customer to improve product performance; and (c) automatically sending products to the customer in accordance with the product replenishment plan over the replenishment schedule.

A computer system in accordance with one or more embodiments comprises at least one processor, memory associated with the at least one processor, a display, and an automatic product replenishment program supported in the memory. The program includes a plurality of instructions stored therein which, when executed by the at least one processor, cause the at least one processor to: (a) receive an order for products to be sent to a customer on a given replenishment schedule; and (b) determine a product replenishment plan for evolving the products to be sent to the customer to improve product performance such that products can be automatically sent to the customer in accordance with the product replenishment plan over the replenishment schedule.

### BRIEF DESCRIPTION OF THE DRAWINGS

FIG. 1 is a simplified block diagram of an exemplary network in which an automatic product replenishment system in accordance with one or more embodiments can be implemented.

FIG. 2 is a simplified flowchart illustrating an exemplary automatic product replenishment method in accordance with one or more embodiments.

### DETAILED DESCRIPTION

As described in further detail below, automatic product replenishment methods and systems are provided that evolve products to be replenished to improve product performance.

A variety of products can be sold using the automatic replenishment techniques described herein, including, e.g., skin care products, cosmetics, nutritional products, hair-care products, dietary supplements, pharmaceutical products, and medicinal products. In various examples illustrated herein, the products sold are skin care products. It should be understood however that this is by way of example only and that a variety of other products can be sold using the replenishment techniques described herein.

Traditional automatic replenishment programs for skin care products typically operate as follows. A consumer shopping for a skin care product or product regimen (e.g., a multi-step product regimen) is given the option of enrolling in an automatic replenishment program. The consumer is given information on shipment frequency and any discounts that may apply by enrolling in the program. When enrolling in the automatic replenishment program, the consumer provides his or her billing and shipping information and authorizes the seller to charge the consumer (e.g., through a credit card) for each product shipment. The consumer's billing and shipping information is stored in a database, along with information on the conditions of the automatic replenishment program (products to be replenished, frequency of replenishment, dates of replenishment, billing amount for each replenishment, and shipping information). The database is linked to a program that triggers a replenishment purchase based on the replenishment schedule in the database. For each replenishment, the system retrieves the relevant billing and shipping information to complete the billing process and shipment of the product to the consumer.

Once enrolled in an automatic replenishment program, the consumer will receive a product or products on some regular frequency (e.g., every four weeks or eight weeks). Consumers are typically able to cancel their enrollment in the program at any time. Consumers can also shorten or lengthen the time period between replenishments and adjust the products in their shipments.

For many types of products, including skin care products, it is often important to evolve or modify the products over time to improve product performance. For example, it has been found that it is often important to evolve a user's skin care regimen (or product selection) over time in accordance with the changing needs of the skin to achieve optimal results. Factors that can be considered when optimizing a skin care regimen over time include the following:

1. Product Concentration and Titration: Progressively increasing ingredient levels over time is commonly called “titration,” Titration is most commonly used to address skin irritation. Many skin care ingredients are relatively irritating at the highest, most effective concentrations. It is been found that irritation caused by these products can be dramatically, if not completely, eliminated by gradually increasing the concentration of the ingredients over time. Titration can allow the user's skin to acclimate to the ingredient gradually, so as not to trigger severe irritation. Titration can also be used to address declining efficacy of an ingredient over time as the body builds a tolerance to that ingredient. When certain ingredients are taken regularly for a length of time, the body often does not respond to them as well as it once did, and the original fixed dose becomes less effective. Larger or more frequent doses can be taken to obtain the effect previously achieved with the original dose.

2. Seasonality and Weather Conditions: Weather conditions can play an important role in optimizing a skin care regimen. During winter months, skin can lose its moisture and become much drier in response to lower temperatures and lower humidity. Clinical research has demonstrated that ingredients are absorbed less effectively by drier, less hydrated skin. Consequently, it is often advisable to add specific moisturizing ingredients during the winter months to address this compromised skin condition and ensure proper results from the regimen. By contrast, these moisturizing ingredients can be too emollient in the more humid summer months, leaving skin feeling greasy and tacky.

3. Age: Skin conditions change with age. Ingredients that were sufficient and effective when a user is younger may not be sufficient or effective as the user ages. Consequently, a skin care regimen can be evolved as the user gets older.

4. Product Satisfaction and Adoption: Product usage experience also plays an important role in optimizing a skin care regimen. Skin care ingredients may not be effective if they are not used routinely and as-directed. If a consumer no longer likes a particular product or is simply ready for a change, this is important information in building a better product regimen that the consumer is more likely to use routinely.

An automatic product replenishment system in accordance with various embodiments automatically evolves skin-care and other products to be replenished to improve product performance. The system is preferably accessible by consumers through an ecommerce Website, though it can also be accessed through other means such as by telephone through a customer service representative.

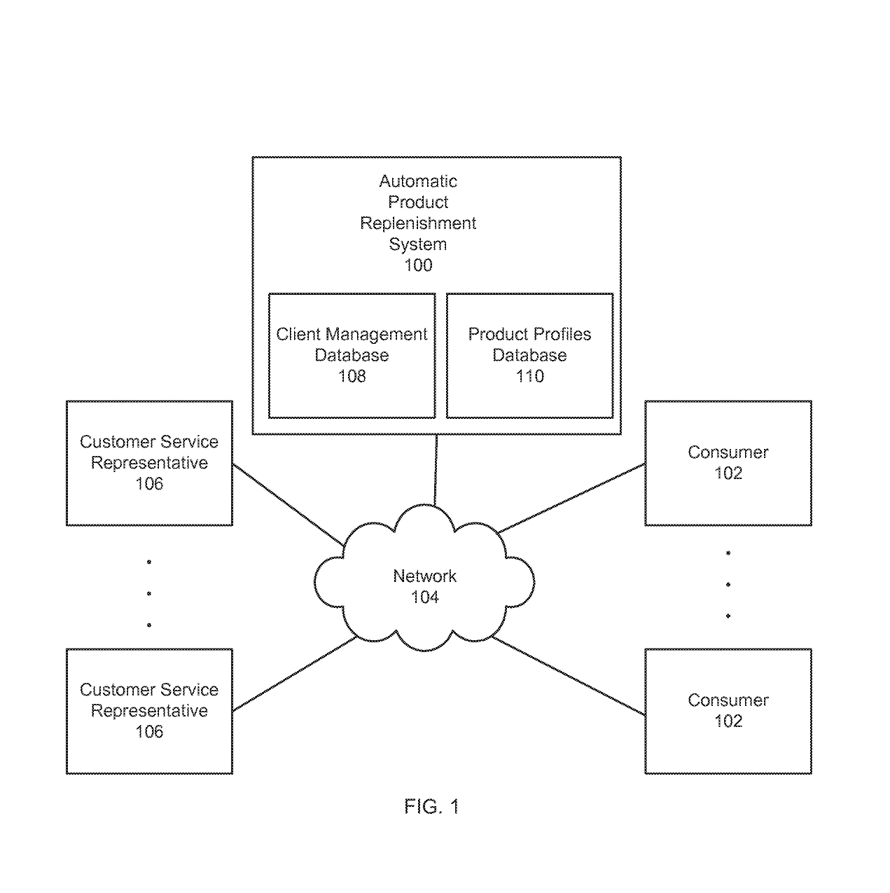

FIG. 1 illustrates an exemplary network, including an automated product replenishment system 100 in accordance with one or more embodiments. The automated product replenishment system 100 is implemented in a computer server system, which communicates with a plurality of client devices 102 operated by customers. The client devices communicate with the system 100 over a communications network 104. The communications network 104 may comprise any network or combination of networks including, without limitation, the Internet, a local area network, a wide area network, a wireless network, and a cellular network. The automated product replenishment system 100 can also be accessed by terminals 106 operated by customer service representatives.

The client devices 102 used to access the automatic product replenishment system 100 can comprise generally any computing device that can communicate with the computer server system including, without limitation, personal computers (including desktop, notebook, and tablet computers), smart phones, personal digital assistants, and cell phones.

Consumers can also access the automated product replenishment system 100 indirectly by telephoning or otherwise communicating with customer service representatives 106. The system includes client service manager terminals, which can be used by customer service representatives to access product catalogs, enable consumers to purchase products from the catalog, and set up client accounts.

The automated product replenishment 100 system preferably includes an e-commerce website accessible by users over the Internet. The website includes a “client account” page and record system for each consumer. The client account page can be accessed either by the consumer directly via the website or indirectly via a phone call to a customer service representative. The client account page allows consumers to input and update information on their product preferences, concerns, and experience with products including product acceptance.

The automated product replenishment system 100 also includes a client management database 108, which stores customer account data, customer product purchase history, and replenishment program rules (e.g., information on replenishment products and frequency).

The automated product replenishment system 100 also includes a product profiles database 110. This database contains basic product information used to optimize the product regimen over time for each product in a product catalog.

The automated product replenishment system 100 includes automatic replenishment software, which when executed, pulls data from the client management and product profiles databases and uses the data to determine product replenishment plans that evolve the products sent to customers.

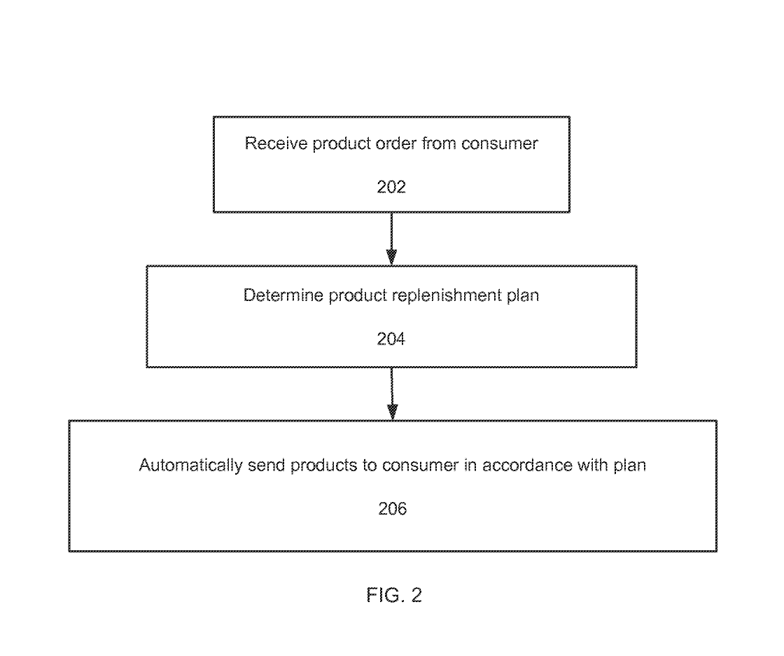

FIG. 2 is a flowchart illustrating an exemplary automatic product method in accordance with one or more embodiments.

At step 202, the consumer places an order for a product. The consumer can place the order through the e-commerce website or by telephone through a customer service representative. When a consumer selects a skin care product or product regimen (e.g., multi-step product regimen), the consumer is given the option of enrolling in an automatic replenishment program. The consumer is notified of the shipment frequency and any discounts that may apply by enrolling in the program. If the consumer agrees to participate in the automatic replenishment program, he or she provides billing and shipping information authorizes the system to charge the consumer (e.g., by credit card) for products sent on the agreed to frequency. Data received from the consumer are stored in the client management database 108, along with the conditions of the automatic replenishment program (products to be replenished, frequency of replenishment, dates of replenishment, billing amount for each product replenishment, and shipping information).

The consumer can be asked to complete a survey that records his or her skin type (e.g., oily, dry, a combination of oily and dry), skin condition (e.g., sensitivity, breakouts, texture, tone), product and usage preferences (e.g., tolerance to irritation, product form preferences, tradeoffs between speed and irritation), and skin care concerns (frustrations, key needs, etc.). This information is referred to herein as a Client Profile.

At step 204, a product replenishment plan for evolving the product to be sent to the customer is determined. The computer server system is programmed to analyze the product information for the products selected by the consumer, consumer information including information from the Client Profile, seasonality, and purchase date to determine a generally optimal product replenishment regimen given the financial constraints of the replenishment agreement. This optimal regimen is loaded into the Client Management Database.

At step 206, products are automatically sent to the consumer in accordance with the product replenishment plan over the replenishment schedule. The database is linked to a program that triggers a replenishment purchase based on the replenishment dates in the database. Upon replenishment, the system retrieves the relevant billing and shipping information to complete the billing process and shipment of the product to the consumer.

Over the course of the replenishment schedule, consumers may update their Client Profile based, e.g., on their experience with the products used. The automated product replenishment system 100 may accordingly modify the product replenishment plan and alter product selection based on the updated information.

The following non-limiting example illustrates a product replenishment plan for evolving a skin care product to be sent to a customer.

PrototypicalAnti-Aging Regimen

| | | Refined | Repair | |
|---|---|---|---|---|
| | Cleanser | Treatment | Treatment | Sunblock |
| January | Mild Cleanser | 0.05% | Skin Barrier | Emollient |
| | | Emollient | Repair | Sunblock |
| | | Retinol | Treatment | |
| March | 2% BHA | 0.075% | Skin Barrier | Emollient |
| | Cleanser | Emollient l | Repair | Sunblock |
| | | Retino | Treatment | |
| May | 2% BHA/2% | 0.1% Retinol | Super | Lightweight |
| | AHA Mild | | Antioxidant | Sunblock + |
| | Exfoliating | | Peptide | Antioxidants |
| | Cleanser | | Treatment | |
| July | 2% BHA/2% | 0.2% Light | Super | Lightweight |
| | AHA Mild | Weight | Antioxidant | Sunblock + |
| | Exfoliating | Retinol | Peptide | Antioxidants |
| | Cleanser | | Treatment | |
| September | 2% BHA/6% | 0.3% Light | Super | Sunblock + |
| | AHA Exfoliating | Weight | Antioxidant | Skin |
| | Cleanser | Retinol | Peptide | |
| | | | Treatment | |
| November | Mild Cleanser | 0.4% | Progressive | Sunblock + |
| | | Emollient | Skin Peel | Skin |
| | | Retinol | Treatment | Barrier Repair |
| January | 2% BHA/2% | 0.4% | Skin Barrier | Sunblock + |
| | AHA Mild | Emollient | Repair | Skin |
| | Exfoliating | Retinol | Treatment | Barrier Repair |
| | Cleanser | | | |

This particular example involves a consumer who has not had significant experience with professional skin care products. The product replenishment plan progresses the consumer through an anti-aging skin care regimen by titrating to significantly higher active levels and altering treatments to improve skin care results.

The system incorporates the key consumer inputs (outlined in the table below) and prioritizes the products in the regimen based on information in the product files. It identifies the “primary product,” which will become the anchor treatment to the plan. It maps this product shipment plan first, and this plan will affect the plans for the other products in the regimen.

Once this replenishment plan is mapped, the “secondary” product map is planned. The secondary product map is driven by all the inputs, which include the primary product map. Then, the “tertiary product” product map is planned. This map is driven by all the inputs, which include the primary and secondary product maps. Finally, the “quaternary product” product map is planned, using all the inputs including the primary, secondary and tertiary product maps.

| | |
|---|---|
| Inputs | The consumer is new to professional skin care - e.g., the |
| | consumer does not have experience with high levels of Retinol or |
| | Alpha Hydroxy Acids. |
| | The consumer has indicated that their skin is somewhat |
| | “sensitive.” This suggests that their skin barrier function is likely |
| | compromised. |
| | The consumer has normal to oily skin. |
| | They have acquired this regimen to even their skin tone, reduce |
| | hyperpigmentation, and smooth out fine lines. |
| | The first shipment will be made in January, and product will be |
| | replenished every 60 days. |
| Retinol (primary | The objectives of the Retinol map outlined above are: (1) to |
| product) | advance the consumer to the highest, most effective levels of |
| | retinol and (2) to address season affects. |
| | At concentrations greater than .2%, Retinol is a highly effective skin |
| | care ingredient. |
| | Retinol has a dose-related response. Performance continues to |
| | improve as the concentration is increased to 1.0%. |
| | However, retinol can be very irritating at these high levels. |
| | We can mitigate or eliminate this irritation by titrating up (or |
| | building up) to these higher levels over time. |
| | In the example above, the program/system mapped out a |
| | replenishment program that titrates the consumer from .05% to |
| | .40% over the course of 12 replenishments |
| | This map will be altered by the program/system if the consumer |
| | updates their product profile and indicates they are experiencing |
| | irritation. |
| | Another change mapped out by the program/system is the variant |
| | of retinol used. A more emollient and moisturizing retinol product |
| | is shipped during the winter months. This helps keep the skin |
| | hydrated during the dry months, when the skin is dehydrated by |
| | dry indoor heat. A much lighter weight, less emollient variant of |
| | the retinol product is shipped during the summer months. The |
| | emollient Retinol is too heavy for these more humid months. The |
| | program can incorporate the location/shipping-address of the |
| | consumer in this mapping selection to reflect different climates |
| | across the country. |
| Repair Treatment | The objectives of the repair treatments are: (1) to prepare the skin |
| (secondary product) | for a more a more aggressive professional skin care treatment, (2) |
| | to create the ideal conditions for the primary treatment, and (3) to |
| | advance the skin care results by repairing prior skin damage. |
| | To prepare the skin for this more advanced skin care regimen, the |
| | treatment product initially focuses on repairing the skin barrier |
| | function. The skin barrier function is the mechanism in the outer |
| | most layer of the skin (the epidermis) that essentially maintains the |
| | integrity of the skin - keeping the “good stuff” in and the “bad stuff” |
| | out. Skin barrier damage is a common issue among consumers |
| | starting out with a professional skin care regimen. |
| | Strengthening the skin barrier function also achieves the second |
| | benefit of creating an ideal skin condition for the primary |
| | treatments. |
| | The program/system determines that the skin barrier should be |
| | repaired by the third replenishment. For this replenishment, the |
| | program/system selects a higher potency antioxidant and peptide |
| | treatment. This will more effectively address the objectives #2 and |
| | #3 - creating an ideal skin condition for the primary product and |
| | advancing the skin care results. |
| | Finally, the program/system selected a skin peel for the November |
| | replenishment. This is a season-driven selection, and made to |
| | address “fall skin”- a common condition among many skin care |
| | consumers. The peel turns over skin cell build up from the fall and |
| | enhances the complexion for the winter. |
| Sunblock (tertiary | The objectives of the sunblock are: (1) to prepare the skin for a |
| product) | more aggressive professional skin care treatment, (2) to address |
| | season changes and (3) provide effective UV protection while |
| | advancing skin care results. |
| | To prepare the skin for this regimen and create an ideal skin |
| | condition for the primary and secondary treatment products, the |
| | program/system selected a sunblock that includes higher levels of |
| | skin barrier repair ingredients. |
| | To address seasonal changes, the program/system selected more |
| | emollient sunblock products in the winter and lighter weight |
| | products in the summer. |
| | To provide more effective UV protection, the summer sunblock |
| | product incorporates higher antioxidant levels to address |
| | increased UV exposure. |
| | To advance skin care results (e.g., improved skin tone and |
| | texture), the fall-winter-spring season sunblock products increase |
| | the levels of repair peptides. |
| Cleanser | The objectives of the Cleanser map outlined above are to: (1) |
| (quaternary product) | support the consumers' transition from traditional skin care |
| | products to professional skin care ingredients, (2) minimize the |
| | irritation during the potentially most irritating evolutions of the |
| | regimen and (3) advance the results of the regimen by increasing |
| | the exfoliating benefits of the cleanser. |
| | To support the transition from traditional skin care products to this |
| | regimen, the program/system selected very mild cleansers for the |
| | initial shipments. The professional ingredients in the balance of |
| | the regimen will likely be much more active than the ingredients |
| | this consumer has used in the base. The program selected the |
| | mildest cleansers for the first two shipments to ensure they didn't |
| | contribute to skin irritation. |
| | To minimize irritation in subsequent shipments, the |
| | program/system identifies other changes in the regimen that might |
| | trigger irritation - e.g., the addition of a skin peel in the regimen. |
| | During these periods, the program/system selects a milder |
| | cleanser. |
| | To advance the results of the regimen, the cleanser map increases |
| | active levels of the alpha hydroxyl acid ingredients. This |
| | encourages increased exfoliation and improves the performance of |
| | the primary and secondary treatment products. |

The processes of the automatic product replenishment system 100 described above may be implemented in software, hardware, firmware, or any combination thereof. The processes are preferably implemented in one or more computer programs executing on a programmable computer (which can be part of the server computer system) including at least one processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method for automatic product replenishment, comprising the steps of:
(a) receiving an order at a computer system for products to be sent to a customer on a given replenishment schedule;
(b) determining a product replenishment plan using the computer system for evolving the products to be sent to the customer to improve product performance; and
(c) automatically sending products to the customer in accordance with the product replenishment plan over the replenishment schedule.

2. The method of claim 1, wherein the products comprise skin care products that are part of a multi-step skin care regimen.

3. The method of claim 1, wherein the products are evolved by titration.

4. The method of claim 1, wherein the products are evolved by progressively modifying ingredient levels to mitigate skin irritation.

5. The method of claim 1, wherein the products are evolved by progressively increasing ingredient levels to mitigate declining efficacy of an ingredient over time.

6. The method of claim 1, wherein the products are evolved in accordance with seasonality or weather conditions.

7. The method of claim 1, wherein the products are evolved to account for consumer aging.

8. The method of claim 1, wherein the products are skin care products evolved to account for consumer skin type, skin condition, or consumer product and usage preferences.

9. The method of claim 1, further comprising storing consumer data.

10. The method of claim 9, wherein the consumer data includes information on customer product preferences.

11. The method of claim 9, wherein the consumer data includes information on consumer skin type, skin condition, product and usage preferences, and skin care conditions.

12. The method of claim 9, wherein the consumer data includes customer account data, product purchase history data, and consumer replenishment program rules.

13. The method of claim 9, further comprising periodically receiving updated consumer data and repeating step (b) based on the updated data.

14. The method of claim 1, wherein the computer system comprises a Web server, and wherein step (a) comprises receiving an order from a client device operated by the customer over a communications network.

15. A computer system, comprising:
at least one processor;
memory associated with the at least one processor;
a display; and
an automatic product replenishment program supported in the memory, the program having a plurality of instructions stored therein which, when executed by the at least one processor, cause the at least one processor to:
(a) receive an order for products to be sent to a customer on a given replenishment schedule; and
(b) determine a product replenishment plan for evolving the products to be sent to the customer to improve product performance such that products can be automatically sent to the customer in accordance with the product replenishment plan over the replenishment schedule.

16. The computer system of claim 15, wherein the products comprise skin care products that are part of a multi-step skin care regimen.

17. The computer system of claim 15, wherein the products are evolved by titration.

18. The computer system of claim 15, wherein the products are evolved by progressively modifying ingredient levels to mitigate skin irritation.

19. The computer system of claim 15, wherein the products are evolved by progressively increasing ingredient levels to mitigate declining efficacy of an ingredient over time.

20. The computer system of claim 15, wherein the products are evolved in accordance with seasonality or weather conditions.

21. The computer system of claim 15, wherein the products are evolved to account for consumer aging.

22. The computer system of claim 15, wherein the products are skin care products evolved to account for consumer skin type, skin condition, or consumer product and usage preferences.

23. The computer system of claim 15, further comprising a database for storing consumer data.

24. The computer system of claim 23, wherein the consumer data includes information on customer product preferences.

25. The computer system of claim 23, wherein the consumer data includes information on consumer skin type, skin condition, product and usage preferences, and skin care conditions.

26. The computer system of claim 23, further comprising receiving updated consumer data and repeating (b) based on the updated data.

27. The computer system of claim 23, wherein the consumer data includes customer account data, product purchase history data, and consumer replenishment program rules.

28. The computer system of claim 15, wherein the computer system comprises a Web server, and wherein the Web server receives an order from a client device operated by the customer over a communications network.
